(19) United States
(12) Patent Application Publication
(10) Pub. No.: US 2019/0236618 A1
(43) Pub. Date: Aug. 1, 2019

(54) RECORDING MEDIUM IN WHICH DEGREE-OF-INTEREST EVALUATING PROGRAM IS RECORDED, INFORMATION PROCESSING DEVICE, AND EVALUATING METHOD

(71) Applicant: FUJITSU LIMITED, Kawasaki-shi (JP)

(72) Inventors: Teruyuki Sato, Tama (JP); Koichiro NIINUMA, Pittsburgh, PA (US)

(73) Assignee: FUJITSU LIMITED, Kawasaki-shi (JP)

(21) Appl. No.: 16/225,510

(22) Filed: Dec. 19, 2018

(30) Foreign Application Priority Data
Jan. 26, 2018 (JP) 2018-011339

(51) Int. Cl. G06Q 30/02; H04W 4/02; H04W 88/02

(52) U.S. Cl. CPC G06Q 30/0201; H04W 88/02; H04W 4/027; H04W 4/026

(57) ABSTRACT

A non-transitory recording medium recording a degree-of-interest evaluating program which causes a computer to execute a process, the process includes: identifying,_based on a combination of a terminal motion amount relating to a change in an orientation of a terminal and information on the orientation of the terminal, a first cluster in which the terminal motion amount and the orientation of a terminal are in a specific state from a plurality of clusters into which the terminal motion amount is categorized; determining whether the terminal motion amount belongs to an inattentive viewing state of an operator of the terminal for content based on an operating state of the terminal; and determining a parameter to evaluate a degree of interest of the operator of the terminal based on the terminal motion amount which belongs to the first cluster and the terminal motion amount which belongs to the inattentive viewing state.

### CROSS-REFERENCE TO RELATED APPLICATION

This application is based upon and claims the benefit of priority of the prior Japanese Patent Application No. 2018-11339, filed on Jan. 26, 2018, the entire contents of which are incorporated herein by reference.

### FIELD

The embodiment discussed herein is related to a degree-of-interest evaluating program, a device, and an evaluating method.

### BACKGROUND

Desired goods, services, or the like are purchased at electronic commerce (EC) sites by using mobile terminals such as smartphones or tablets.

Related technologies are disclosed in, for example, Japanese Laid-open Patent Publication Nos. 2011-075559, 2013-218417, 2015-141530, 2010-252861, and 2011-197992. The related technologies are also disclosed in, for example, Japanese National Publication of International Patent Application No. 2017-524182.

### SUMMARY

According to an aspect of the embodiments, a non-transitory recording medium recording a degree-of-interest evaluating program which causes a computer to execute a process, the process includes: identifying,_based on a combination of a terminal motion amount relating to a change in an orientation of a terminal and information on the orientation of the terminal, a first cluster in which the terminal motion amount and the orientation of a terminal are in a specific state from a plurality of clusters into which the terminal motion amount is categorized; determining whether the terminal motion amount belongs to an inattentive viewing state of an operator of the terminal for content based on an operating state of the terminal; and determining a parameter to evaluate a degree of interest of the operator of the terminal based on the terminal motion amount which belongs to the first cluster and the terminal motion amount which belongs to the inattentive viewing state.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a configuration of a degree-of-interest evaluating system according to the embodiment.

FIG. 2 illustrates an example of a distribution of a terminal orientation.

FIG. 3 illustrates an example of a graph of the reliability.

FIG. 4 illustrates an example of a graph of the reliability of user 1 and user 2.

FIG. 5 illustrates an example of two-dimensional clustering processing for a terminal orientation and a terminal motion amount.

FIG. 6 is a block diagram schematically illustrating a configuration of a computer functioning as an information processing terminal.

FIG. 7 is a block diagram schematically illustrating a configuration of a computer functioning as a content server.

FIG. 8 is a flowchart illustrating an example of degree-of-interest evaluating processing according to the embodiment.

FIG. 9 is a flowchart illustrating an example of processing for calculating a first motion amount.

FIG. 10 is a flowchart illustrating an example of processing for calculating a second motion amount.

### DESCRIPTION OF EMBODIMENTS

For example, when a customer purchases desired goods, a desired service, or the like at an EC site by using a mobile terminal, assistance is provided up to a point where the customer performs actual purchasing.

For example, based on an operating history in reading-type content having been browsed by a user, another item of content suitable for the user is recommended.

For example, a score indicative of preference of the user is calculated with a weight assigned to an operating log for content. Here, the weight is varied on a user property-by-user property basis.

For example, a device that detects a motion of a terminal device with a sensor is provided. This device assumes a movement based on measurement information such as moving velocities and distances in the horizontal and vertical directions, an angle of rotation, and an angular velocity so as to perform interaction with the terminal device.

For example, it may be difficult to recognize whether the user is actually interested in content of a web page or in what part of the web page the user is interested in accordance with a personal operational habit.

For example, parameters for calculating the degree of interest corresponding to the characteristics of the user may be obtained.

Nowadays, an increasing number of people choose a way of obtaining information in which desired information is obtained by searching information with terminals as smart devices such as smartphones and tablets in addition to personal computers. In a scene of use as described above, when the degree of interest of users is able to be detected, new services are possible in addition to the effects for marketing. As web customer care in EC sites as a representative example, taking measures in the one-to-one relationships in accordance with preferences of individual customers is receiving attention. In this case, when not only information on to what web page the customer has accessed but also information on whether the customer is actually interested in the content of a web page or in what part of the web page the user is interested are recognizable, this information may be important information as customer information. When such data and purchase data are gathered, what kind of a person has purchased and, when a persona is assumed, what kind of measures are to be taken may be implied.

With such situations as a background, there is a technique of evaluating the degree of interest in the content of a web page with the motion of the terminal taken into consideration.

This technique provides information based on the degree-of-interest evaluation in real time. This technique focuses on reduction of the terminal motion while the user is browsing content of interest because the user holds the terminal stationary for attentive viewing of the screen. With this technique, based on the assumption that there exists an interest when the terminal motion per unit period of time is kept at or below a certain level for a certain period of time, a model expression is defined to assign a weight of reliability so as to reduce the degree of interest when the terminal motion increases. Since the baseline value of the terminal motion depends on an operational habit of individual users, the degree-of-interest evaluation adjusted for individual users becomes possible by controlling assignment of the weight of reliability for the individual users.

When evaluating the degree of interest by focusing on the terminal motion as described above, it is desirable that operational habits of individual users be considered for the evaluation. As related art, there exist the following techniques as examples in which detection of a movement of a terminal with an acceleration sensor or an angular velocity sensor is employed for a gaming machine or motion determination.

For example, there exists a technique in which, during playing a game, a habit of the user regarding the amount of twist for a shooting operation is recognized, and reduction for cancellation is performed so as to increase ease of playing the game (first technique). There exists another technique that focuses on a “preoperation”, which is a habit exhibited immediately before a motion consciously performed by the user, and a “postoperation”, which is a habit exhibited immediately after such a motion, and removes the preoperation and the postoperation (second technique). Furthermore, there exists a technique that is not a specific example as described above but a model learning technique in which a global model stored in a server is downloaded to a user device and a local model is learned in the user device (third technique).

However, there are the following problems with the above-described related-art techniques. The first and second techniques address problems by focusing on different characteristic amounts which exist for different applied items. For example, since the characteristic amounts unique to the techniques are used, it is difficult to apply these to use in evaluating the degree of interest. The third technique has sequences for downloading the model and uploading the model, and accordingly, is not suitable for use in real-time browsing of web sites with a usual browser.

Thus, when evaluating the degree of interest by focusing on the terminal motion, it is difficult to recognize, during browsing of a web page for example, whether the user is actually interested in the content of a web page or in what part of the web page the user is interested in accordance with an operational habit of a person.

Thus, according to the embodiment, for example, an operational habit of a user browsing a web page is identified from the amount of the terminal motion and the orientation of the terminal. For example, a technique of evaluating the degree of interest on a user-by-user basis is provided by obtaining the amount of the terminal motion in an attentive viewing state and an inattentive viewing state and determining parameters of reliability for evaluating the degree of interest.

Hereinafter, an example of the embodiment will be described in detail with reference to the drawings.

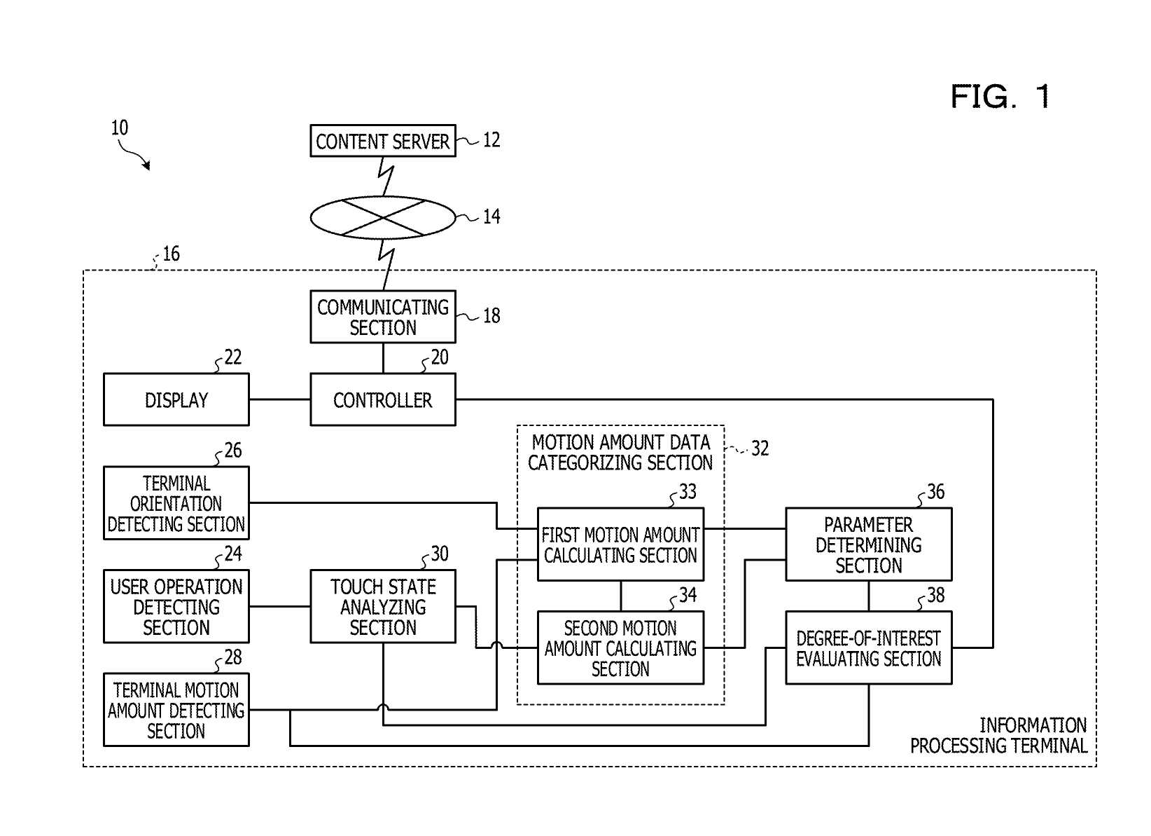

As illustrated in FIG. 1, a degree-of-interest evaluating system 10 according to the embodiment includes a content server 12 and an information processing terminal 16 (also simply referred to as “terminal” hereinafter). The content server 12 and the information processing terminal 16 are connected to each other through a network 14 such as the Internet. The information processing terminal 16 is an example of a degree-of-interest evaluating device.

The content server 12 transmits content to the information processing terminal 16 in response to a request signal for the content from the information processing terminal 16.

The information processing terminal 16 includes a communicating section 18, a controller 20, a display 22, a user operation detecting section 24, a terminal orientation detecting section 26, a terminal motion amount detecting section 28, a touch state analyzing section 30, a motion amount data categorizing section 32, a parameter determining section 36, and a degree-of-interest evaluating section 38. The motion amount data categorizing section 32 is an example of a categorizing section, and the parameter determining section 36 is an example of a determining section.

The communicating section 18 transmits information to and receives information from the content server 12. For example, the communicating section 18 receives content transmitted from the content server 12. The communicating section 18 transmits to the content server 12 a request signal for content output from the controller 20, which will be described later.

The controller 20 controls the display 22, which will be described later, so as to display the content received by the communicating section 18.

The display 22 is realized by a display such as, for example, a liquid crystal display (LCD) or an organic electroluminescence display (OELD). In the display 22, changes in screen occur in accordance with, for example, an input operation such as a touch by the user or the like. The display 22 presents the content in accordance with the control performed by the controller 20.

While the content is being displayed in the information processing terminal 16, the user operation detecting section 24 accepts input of operations by the user from a touch screen superposed on the display 22 so as to detect input operations by the user and the presence/absence of the input operations. For example, the user operation detecting section 24 detects the types of the input operations by the user such as tapping, flicking, swiping, and pinching. The user operation detecting section 24 detects a scrolling operation that scrolls the screen based on the types of the input operations. The user operation detecting section 24 measures operating time of operations out of a unit period of time. The operating time includes a scrolling operating time during which the scrolling operation is performed. The user operation detecting section 24 measures non-operating time during which no operation is performed out of the unit period of time. Thus, the user operation detecting section 24 detects operating information including examples of operating states of the information processing terminal 16, that is, the type of an input operation, time of day of the input operation, a contact position, the operating time and non-operating time in a unit period of time.

The terminal orientation detecting section 26 detects the orientation of the terminal in each unit period of time. The terminal orientation detecting section 26 uses, for example, a value of a three-axis angular acceleration sensor or a value of a three-axis magnetic sensor that is obtained from data obtained from a nine-axis gyrosensor as gravitational acceleration, azimuth compass, and further, inertial force data. The orientation is obtained from the gravitational acceleration in the direction of the normal to the screen of the terminal (z axis). The terminal orientation in each unit period of time is an example of information on a terminal orientation.

The terminal motion amount detecting section 28 detects a sensor value relating to the terminal motion in each unit period of time. According to the embodiment, the terminal motion amount detecting section 28 is described as a sensor in the form realized by a nine-axis sensor. The nine-axis sensor includes the following three types of sensors: a three-axis angular velocity sensor; a three-axis acceleration sensor; and a three-axis geomagnetic sensor. However, the terminal motion amount detecting section 28 may be realized by one or more types of the above-described three types of the sensors.

The touch state analyzing section 30 detects an operating state in accordance with a touch state that indicates whether the touch screen is being touched and the operating types of touching. The operating types of touch include, for example, zooming and scrolling. The operating states due to operations of these operation types, for example, a start of touch, continuing touch, leave (non-touch state such as an end of touch), a scrolling position, and a scrolling speed are detected. The non-touch state is an example of a case where the touch state is non-contact.

A method of calculating the degree of interest that is a precondition of the embodiment is described. As represented in expression 1 below, the degree of interest according to the embodiment is calculated based on an operating type coefficient, operating time, and the reliability. The degree-of-interest evaluating section 38 will be described later.

degree of interest=Σ(operating type coefficient×operating time×reliability) (expression 1).

The operating type coefficient is determined based on the scrolling speed calculated by the touch state analyzing section 30, the sensor value detected by the terminal motion amount detecting section 28, and so forth. It is sufficient that the operating type coefficient be appropriately determine in accordance with the operation on which attention is to be focused. The operating time is the operating time detected by the user operation detecting section 24. The reliability is determined based on the attentive viewing state and the inattentive viewing state. The attentive viewing state and the inattentive viewing state are based on a principle that a movement of the terminal reduces while the user is attentively viewing the screen of the smartphone with interest. For calculation of the degree of interest, the non-operating time may be used in addition to the operating time.

Hereinafter, the principle of the reliability is described.

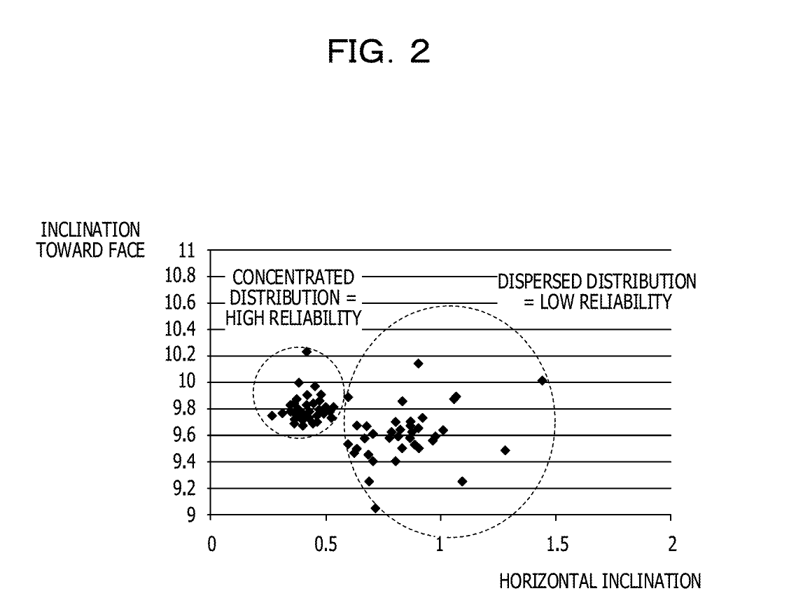

FIG. 2 illustrates a distribution of the terminal orientation. In FIG. 2, the horizontal axis represents inclination of the terminal in the horizontal direction and the vertical axis represents inclination relative to the perpendicular direction (angle relative to the vertical direction) when the terminal faces the face of the user. A region where the distribution is concentrated is a region of attentive viewing. A region where the distribution is enlarged and largely dispersed is considered to be a region where the user skips the content. For example, in the case of a personal computer, whether the user skips the content is able to be determined by measuring the scrolling speed of a mouse. In the case of a touch operation in the smartphone, a movement is partially caused due to inertia even when touching is not performed. For example, there occurs inertial scrolling in the case of skipping. Accordingly, the distribution of the orientation and the inertial scrolling may be reflected in the degree of interest by considering the distribution of the orientation and the inertial scrolling as the reliability. When the distribution of the orientation is concentrated, the reliability is increased. In contrast, when the distribution is dispersed (for example, a case where inertial scrolling is assumed to occur), the reliability is reduced. This is the basic principle of the reliability in calculating the degree of interest.

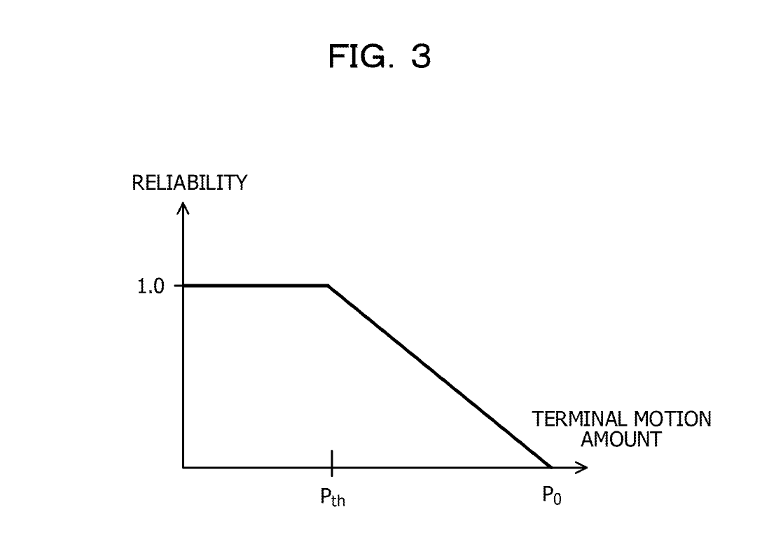

Based on the principle that the movement of the terminal reduces in the attentive viewing state as described above, according to the embodiment, a curve of the reliability that reduces as the amount of the terminal motion increases is thought as illustrated in FIG. 3. In this reliability curve, personal characteristic parameters are able to be represented by two thresholds. As illustrated in the graph of reliability in FIG. 3, one of the thresholds is a threshold Pₜₕ of the amount of the terminal motion with which the reliability starts to reduce from its largest value and the other threshold is a terminal motion amount P₀ where the reliability is smallest (for example, zero).

Pₜₕ represents an average terminal motion amount in the attentive viewing state and is able to be regarded as, for example, an average terminal motion amount in a cluster (the details will be described later) where the distribution is concentrated most. Thus, it is possible that the reliability is treated as high. P₀ represents an average terminal motion amount in the inattentive viewing state. P₀ is an average terminal motion amount when the distributions of the orientation and the terminal motion amount (the details will be described later) are enlarged because of the inclusion of various movements of the terminal (during scrolling, simply held by the user, and so forth). Thus, the reliability is able to be treated as low.

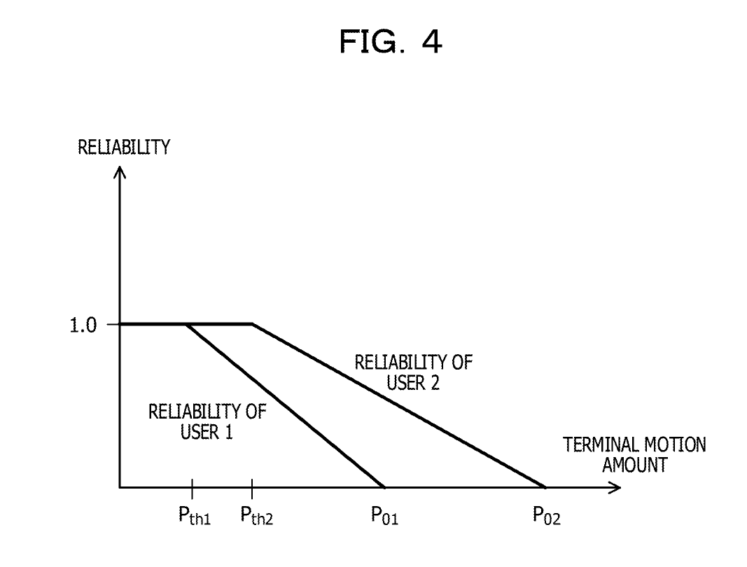

Although the details will be described later, when, as the above-described Pₜₕ and P₀, the thresholds for the cases where the distributions of the orientation and the terminal motion amount are larger and small are respectively set, these thresholds are desirably determined in accordance with the personal characteristics of the users because different users have different operational habits. FIG. 4 illustrates an example of a graph of the reliability of user 1 and the reliability of user 2. In FIG. 4, user 1 is a person whose motion when operating the terminal while holding the terminal is small (for example, a person who holds the terminal with both hands), and user 2 is a person whose motion when operating the terminal while holding the terminal is large (for example, a person who holds the terminal with one hand). When the threshold Pₜₕ of the terminal motion amount where the reliability starts to reduce from the largest value is inappropriately set for user 1 or user 2, it would lead to a situation in which the user who actually has no interest is regarded as having interest or the user who actually has interest is regarded as having no interest. Thus, the adaptation to the personal characteristics is desirable.

The motion amount data categorizing section 32 includes a first motion amount calculating section 33 and a second motion amount calculating section 34.

The first motion amount calculating section 33 categorizes the terminal motion amount into a plurality of clusters based on a combination of the terminal motion amount regarding the terminal orientation per unit period of time and the terminal orientation in each unit period of time. The first motion amount calculating section 33 identifies a cluster corresponding to the attentive viewing state of the operator of the terminal for the content. The first motion amount calculating section 33 calculates the motion amount in the identified cluster of the attentive viewing state. The terminal motion amount used by the first motion amount calculating section 33 is obtained by calculating the sums of the squares of the sensor values detected by the terminal motion amount detecting section 28 (the sensor values of one of the three-axis angular velocity sensor, the three-axis acceleration sensor, and a three-axis geomagnetic sensor) and integrating and logarithmically transforming the calculated values in the unit period of time. The attentive viewing state is an example of a specific state.

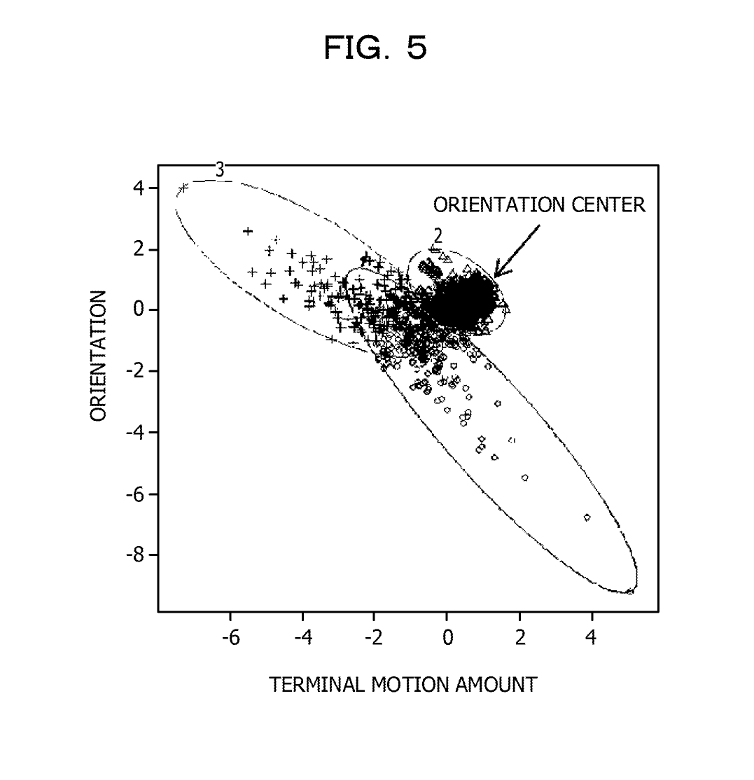

The cluster of the attentive viewing state is obtained from an average of the terminal motion amount when the terminal orientation is fixed. As illustrated in FIG. 5, the terminal orientation and the terminal motion amount are subjected to two-dimensional clustering processing. According to the embodiment, the cluster in the attentive viewing state is categorized by considering a cluster having a small cluster radius by clustering.

The reason why such a two-dimensional clustering is performed is that, for example, small values of the terminal motion amount may be incidentally mixed, as sampling inliers, with large values of the terminal motion amount in inattentive viewing. It is known from an experiment that the terminal motion amount concentrating at the center of the orientation where the orientation is stabilized and the large terminal motion amount and small terminal motion amount scattered in other regions than the orientation center are obtained as different clusters as a result of cluster categorization. It is also known that the radius of the clusters is comparatively large in regions other than the orientation center. The increase in radius of the clusters means that the terminal is not stabilized and the user does not attentively view the terminal. Thus, the cluster having a small radius is categorized as that of the attentive viewing state. FIG. 5 illustrates an example of two-dimensional clustering. It is understood that, out of a plurality of clusters, the cluster of the attentive viewing state where the terminal motion amount concentrated at the orientation center. Thus, clustering is performed with the orientation center regarded as the attentive viewing state.

Clustering is performed by, for example, a cluster analysis based on Euclidean distances in a two-dimensional plane. At this time, clustering is performed by providing three or more (for example, five) of the clusters so as not to include, for example, outliers of the terminal motion amount. The terminal motion amount of the cluster centroid is calculated for clusters having a smallest terminal motion amount and a second smallest terminal motion amount out of the clusters. To categorize the cluster of attentive viewing, first, two of the clusters having a small terminal motion amount of the cluster centroid are selected as cluster candidates. Next, for the cluster including a smallest terminal motion amount of the cluster centroid, whether the terminal motion amount of the cluster centroid of this cluster is larger than a predetermined threshold is checked. The threshold here corresponds to a minimum value of accuracy of the gyrosensor included in the terminal itself. When the terminal motion amount in question is larger than the threshold, the cluster centroid of this cluster is determined as a first motion amount. When the terminal motion amount in question is smaller than the threshold, the cluster centroid of the second smallest cluster is determined as a first motion amount. In the attentive viewing state, the terminal motion amount is stabilized, and the radius of the cluster is small in many cases. Thus, the first motion amount is able to be determined from the cluster having the small radius by performing the above-described threshold processing.

The second motion amount calculating section 34 calculates the terminal motion amount based on a predetermined operating state of the terminal and categorizes whether the calculated terminal motion amount belongs to the inattentive viewing state of the operator of the terminal for the content. A second motion amount is calculated from the categorization result. Here, the predetermined operating state is inertial scrolling in which the touch state of the terminal is non-touch (leave) and the screen of the terminal is being scrolled. The terminal motion amount used by the second motion amount calculating section 34 is obtained by calculating the sums of the squares of the sensor values detected by the terminal motion amount detecting section 28 during inertial scrolling and integrating and logarithmically transforming the calculated values.

The inertial scrolling in the second motion amount calculating section 34 starts after the above-described state has been detected and ends when changes in scrolling position are stopped and obtaining of data is terminated. A continuation length from the start to the end of inertial scrolling is obtained based on the time stamps. The second motion amount calculating section 34 calculates an average of the terminal motion amount per unit period of time during inertial scrolling. The second motion amount calculating section 34 determines whether the average terminal motion amount is larger than the first motion amount having been obtained before. When the average terminal motion amount is larger than the first motion amount, this average terminal motion amount is determined as the second motion amount. When the average terminal motion amount is smaller than the first motion amount, the value of the terminal motion amount of the cluster centroid of the cluster having a larger motion amount than the first motion amount obtained in the cluster analysis by the first motion amount calculating section 33 is determined as the second motion amount.

The parameter determining section 36 determines the parameters for evaluating the degree of interest of the operator of the terminal based on the first motion amount belonging to the cluster corresponding to the attentive viewing state and the second motion amount belonging to the inattentive viewing state.

When the terminal motion amount is obtained through logarithmic transformation by the motion amount data categorizing section 32 in the parameter determining processing, the parameter determining section 36 performs processing for returning the terminal motion amount to a linear value by performing index calculation. For example, with respect to the first motion amount and the second motion amount, the threshold parameters Pₜₕ and P₀ are determined as in the following expressions 2 and 3.

Pₜₕ=exp(first motion amount*2+second motion amount)/3) 2.

P₀=exp(second motion amount) 3.

When defining a reliability curve with Pₜₕ and inclination A, for example, Pₜₕ and A are determined, for example, as in the following expressions 4 and 5.

Pₜₕ=exp((first motion amount*2+second motion amount)/3) 4.

Δ=(exp(second motion amount)−Pₜₕ)/9 5.

The parameter determining section 36 performs the converting processing as described above so as to determine the thresholds Pₜₕ and P₀ being the parameters relating to the reliability used for a degree-of-interest evaluating expression.

The degree-of-interest evaluating section 38 calculates the degree of interest based on the scrolling speed calculated by the touch state analyzing section 30, the sensor value detected by the terminal motion amount detecting section 28, the operating time detected by the user operation detecting section 24, and the threshold parameters determined by the parameter determining section 36. The degree-of-interest evaluating section 38 calculates the degree of interest per unit period of time in accordance with the above-described expression 1.

The above-described processing from the determination of the parameters to the calculation of the degree of interest is performed during a period of time in which the content is displayed in the information processing terminal 16, thereby the degree of interest of the user in the content is able to be evaluated in real time.

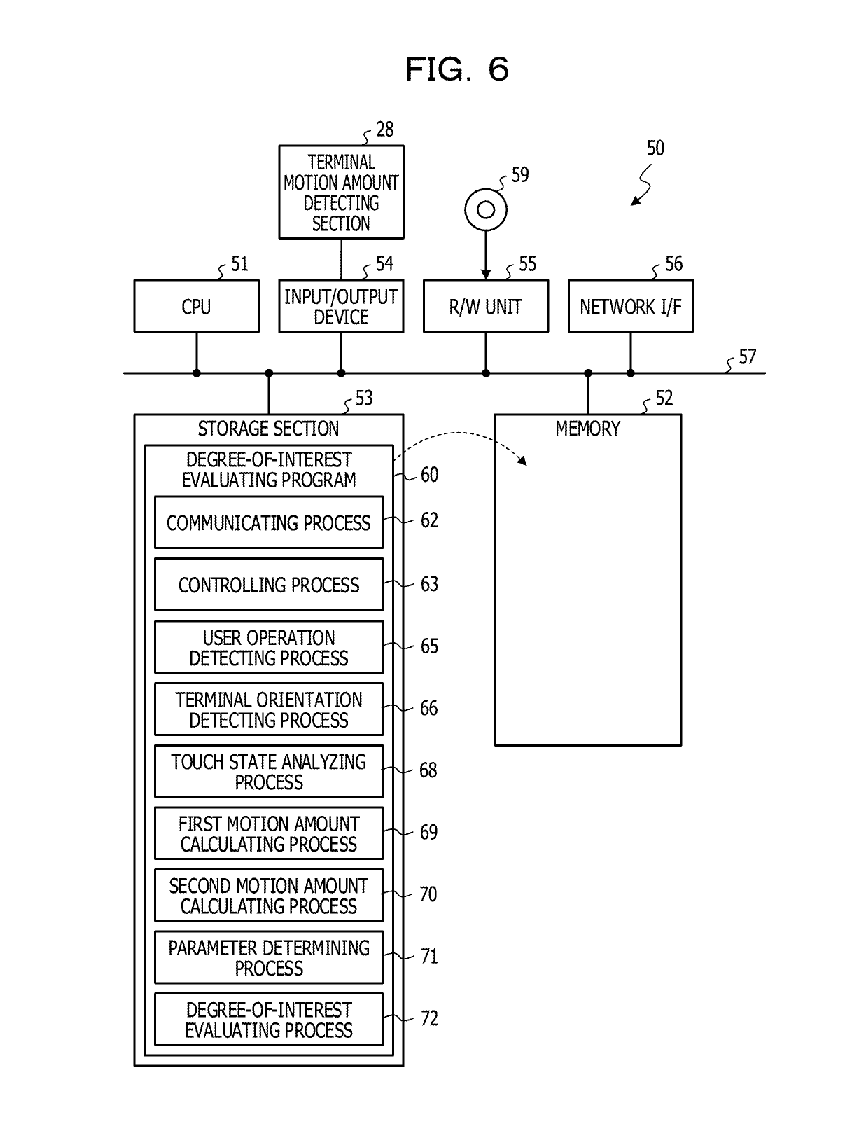

The information processing terminal 16 is able to be realized by, for example, a computer 50 illustrated in FIG. 6. The computer 50 includes a central processing unit (CPU) 51, memory 52 as a temporary storage area, and a nonvolatile storage section 53. The computer 50 also includes an input/output interface (I/F) 54 that includes, for example, the display 22 and a touch screen superposed on the display 22. The computer 50 also includes a read/write (R/W) section 55 that controls reading of data from and writing of data to a recording medium 59. The computer 50 also includes a network I/F 56 connected to a network such as the Internet. The CPU 51, the memory 52, the storage section 53, the input/output I/F 54, the R/W section 55, and the network I/F 56 are connected to one another through a bus 57. The input/output I/F 54 is connected to the terminal motion amount detecting section 28 being the nine-axis sensor.

The storage section 53 is able to be realized by a hard disk drive (HDD), a solid state drive (SSD), a flash memory, or the like. The storage section 53 as a storage medium stores a degree-of-interest evaluating program 60 with which the computer 50 functions as the information processing terminal 16. The degree-of-interest evaluating program 60 includes a communicating process 62, a controlling process 63, a user operation detecting process 65, a terminal orientation detecting process 66, a touch state analyzing process 68, a first motion amount calculating process 69, a second motion amount calculating process 70, a parameter determining process 71, and a degree-of-interest evaluating process 72.

The CPU 51 reads the degree-of-interest evaluating program 60 from the storage section 53, loads the degree-of-interest evaluating program 60 in the memory 52, and sequentially performs the processes included in the degree-of-interest evaluating program 60. The CPU 51 operates as the communicating section 18 illustrated in FIG. 1 when the communicating process 62 is performed. The CPU 51 operates as the controller 20 illustrated in FIG. 1 when the controlling process 63 is performed. The CPU 51 operates as the user operation detecting section 24 illustrated in FIG. 1 when the user operation detecting process 65 is performed. The CPU 51 operates as the terminal orientation detecting section 26 illustrated in FIG. 1 when the terminal orientation detecting process 66 is performed. The CPU 51 operates as the touch state analyzing section 30 illustrated in FIG. 1 when the touch state analyzing process 68 is performed. The CPU 51 operates as the first motion amount calculating section 33 illustrated in FIG. 1 when the first motion amount calculating process 69 is performed. The CPU 51 operates as the second motion amount calculating section 34 illustrated in FIG. 1 when the second motion amount calculating process 70 is performed. The CPU 51 operates as the parameter determining section 36 illustrated in FIG. 1 when the parameter determining process 71 is performed. The CPU 51 operates as the degree-of-interest evaluating section 38 illustrated in FIG. 1 when the degree-of-interest evaluating process 72 is performed. In this way, the computer 50 that executes the degree-of-interest evaluating program 60 functions as the information processing terminal 16. The CPU 51 that executes the program is hardware.

The functions realized by the degree-of-interest evaluating program 60 are also able to be realized by, for example, a semiconductor integrated circuit. Examples of the semiconductor integrated circuit include, for example, an application specific integrated circuit (ASIC).

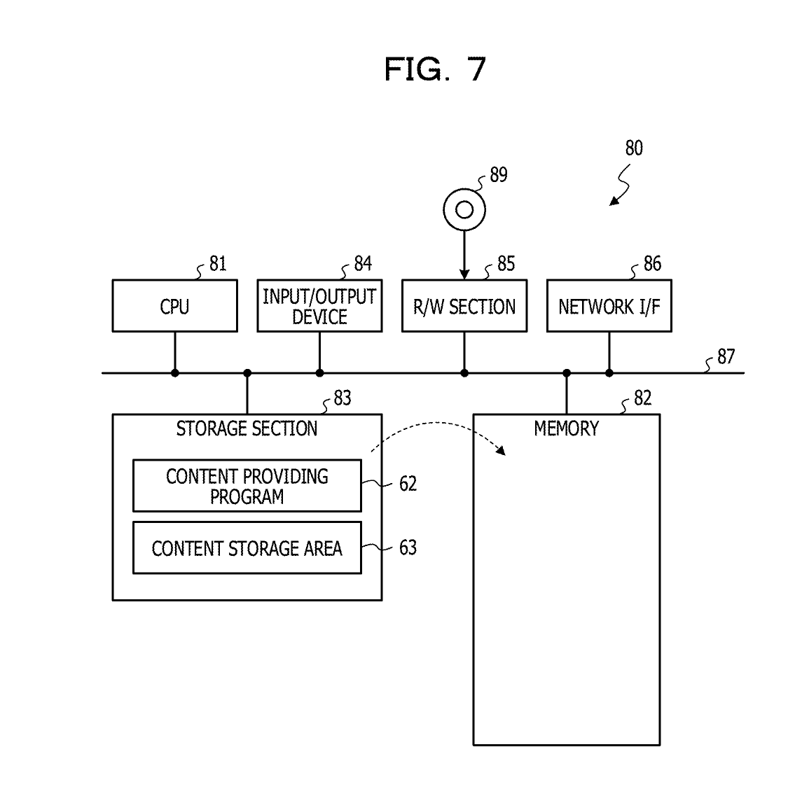

The content server 12 is able to be realized by, for example, a computer 80 illustrated in FIG. 7. The computer 80 includes a CPU 81, memory 82 as a temporary storage area, and a nonvolatile storage section 83. The computer 80 also includes an input/output device 84 that includes, for example, a display and an input device. The computer 80 also includes an R/W section 85 that controls reading of data from and writing of data to a recording medium 89. The computer 80 also includes a network I/F 86 connected to a network such as the Internet. The CPU 81, the memory 82, the storage section 83, the input/output device 84, the R/W section 85, and the network I/F 86 are connected to one another through a bus 87.

The storage section 83 is able to be realized by an HDD, an SSD, a flash memory, or the like. The storage section 83 as a storage medium stores a content providing program 90 with which the computer 80 functions as the content server 12. Content able to be supplied to the information processing terminal 16 is stored in a content storage area 98 in advance.

The functions realized by the content providing program 90 are also able to be realized by, for example, a semiconductor integrated circuit. Examples of the semiconductor integrated circuit include, for example, an ASIC.

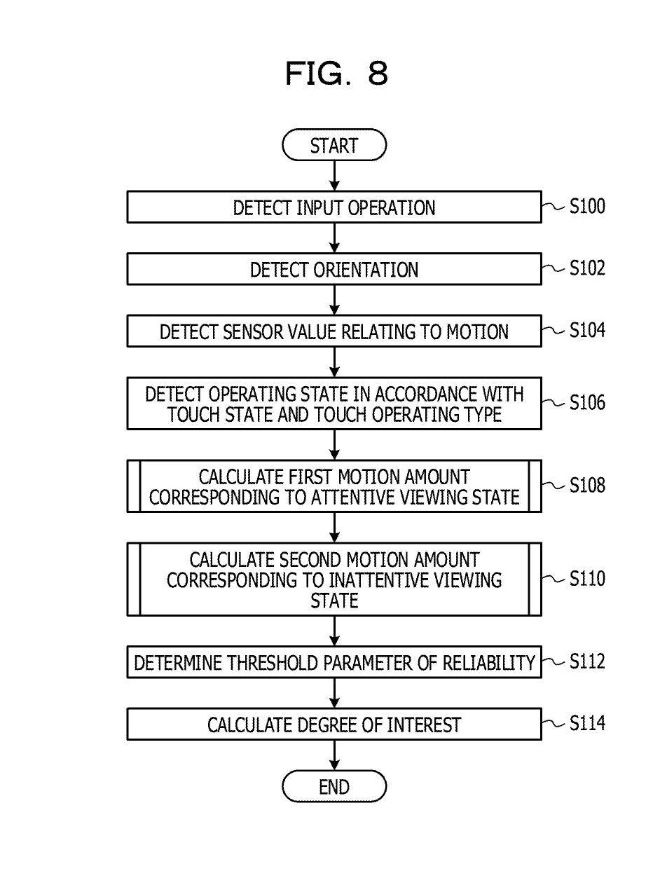

Next, operation of the degree-of-interest evaluating system 10 according to the embodiment is described. In the degree-of-interest evaluating system 10, the information processing terminal 16 receives content from the content server 12. The received content is displayed in the display 22 of the information processing terminal 16, and, when the user operation detecting section 24 accepts input of an operation by the user, the degree-of-interest evaluating processing illustrated in FIG. 8 is performed in the information processing terminal 16. Hereafter, the processing is described in detail.

In step S100, the user operation detecting section 24 detects input operations in each unit period of time of a fixed period of time (herein, 30 seconds). For example, the user operation detecting section 24 detects the operating information including the type of an input operation, time of day of the input operation, the contact position, the operating time and non-operating time in the unit period of time.

In step S102, the terminal orientation detecting section 26 detects the orientation of the terminal in the unit period of time on a period-by-period basis.

In step S104, the terminal motion amount detecting section 28 detects the sensor value relating to the terminal motion at predetermined intervals shorter than the unit period of time. The sensor value is a sensor value of one of the three-axis angular velocity sensor, the three-axis acceleration sensor, and a three-axis geomagnetic sensor. The predetermined intervals are, for example, 200 ms.

In step S106, the touch state analyzing section 30 detects the operating states in accordance with the touch state indicating whether the touch screen is being touched and the operating type of touching. As the operating states, a start of touch, continuing touch, leave (non-touch state such as an end of touch), the scrolling position, and the scrolling speed are detected.

In step S108, the first motion amount calculating section 33 categorizes the terminal motion amount into the plurality of clusters based on the combination of the terminal motion amount regarding the terminal orientation per unit period of time and the terminal orientation for the unit period of time, thereby identifying the cluster corresponding to the attentive viewing state. The first motion amount calculating section 33 calculates the first motion amount in the cluster of the attentive viewing. The details of the processing will be described later.

In step S110, the second motion amount calculating section 34 categorizes whether the terminal motion amount is of the inattentive viewing state based on the first motion amount belonging to the cluster corresponding to attentive viewing state obtained in step S108 and the terminal motion amount in the predetermined operating state of the terminal. The second motion amount calculating section 34 calculates the second motion amount from the categorization result. The details of the processing will be described later.

In step S112, the parameters for evaluating the degree of interest of the operator of the terminal are determined based on the first motion amount belonging to the cluster corresponding to the attentive viewing state and the second motion amount belonging to the inattentive viewing state.

In step S114, the degree of interest is calculated based on the scrolling speed calculated by the touch state analyzing section 30, the sensor value detected by the terminal motion amount detecting section 28, the operating time detected by the user operation detecting section 24, and the threshold parameters determined by the parameter determining section 36.

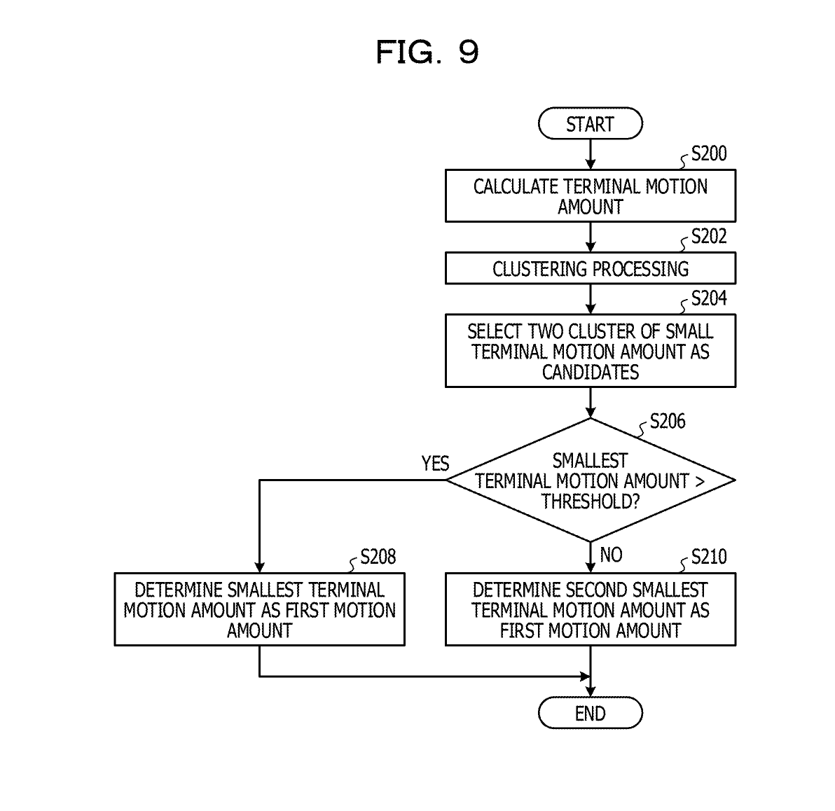

The flow of the first motion amount calculating section 33 in step S108 described above is described in detail with reference to FIG. 9.

In step S200, the terminal motion amount is calculated by obtaining the sums of the squares of the sensor values relating to the terminal motion detected by the terminal motion amount detecting section 28 and integrating and logarithmically transforming the obtained sums in the unit period of time.

In step S202, the two-dimensional clustering processing is performed on the terminal orientation and the terminal motion amount.

In step S204, the terminal motion amount of the cluster centroid is calculated for clusters having a smallest terminal motion amount and a second smallest terminal motion amount out of the clusters resulting from the clustering processing, and two of the clusters having small terminal motion amount of the cluster centroid are selected as the candidates of the cluster.

In step S206, for the cluster having the smallest terminal motion amount of the cluster centroid out of the candidates selected in step S204, whether the terminal motion amount of the cluster centroid of this cluster is larger than the predetermined threshold is determined. When the terminal motion amount is larger than the threshold, the processing proceeds to step S208. Otherwise, the processing proceeds to step S210.

In step S208, the cluster centroid of the cluster including the smallest terminal motion amount of the cluster centroid is determined as the first motion amount.

In step S210, the cluster centroid of the cluster including the second smallest terminal motion amount of the cluster centroid is determined as the first motion amount.

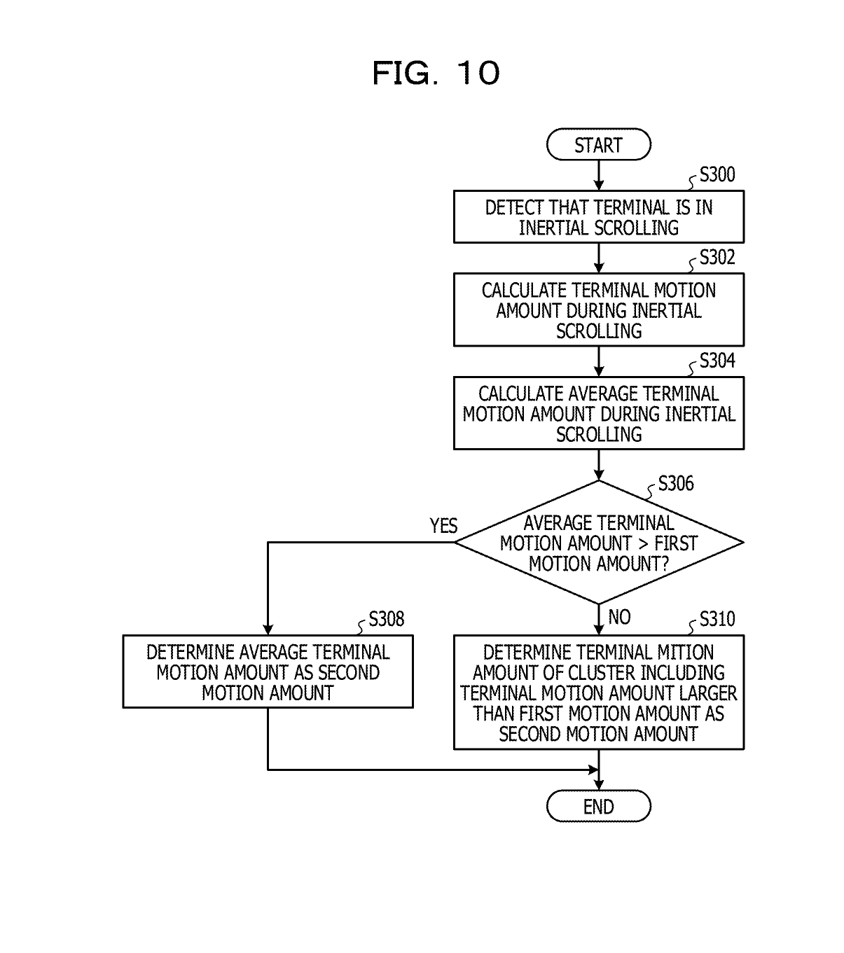

The flow of the second motion amount calculating section 34 in step S110 described above is described in detail with reference to FIG. 10.

In step S300, the state of inertial scrolling is detected in which the touch state of the terminal is non-touch (leave) and the screen of the terminal is being scrolled.

In step S302, the terminal motion amount during inertial scrolling is calculated. The terminal motion amount is a value calculated by obtaining the sums of the squares of the sensor values relating to the terminal motion detected by the terminal motion amount detecting section 28 during inertial scrolling and integrating and logarithmically transforming the obtained sums in the unit period of time.

In step S304, an average terminal motion amount per unit period of time during inertial scrolling is calculated. After the above-described state of step S300 has been detected, the inertial scrolling ends when change in scrolling position are stopped and obtaining of data is terminated. The continuation length from the start to the end of the inertial scrolling is obtained based on the time stamps.

In step S306, whether the average terminal motion amount during inertial scrolling obtained in step S304 is larger than the first motion amount is determined. When the average terminal motion amount is larger, the processing proceeds to step S308. Otherwise, the processing proceeds to step S310.

In step S308, the average terminal motion amount during inertial scrolling obtained in step S304 is determined as the second motion amount.

In step S310, the cluster including the terminal motion amount of the cluster centroid larger than that of the cluster to which the first motion amount belongs determined in the above-described step S208 or S210 is selected, and the terminal motion amount of the cluster centroid of the selected cluster is determined as the second terminal motion amount.

As has been describe, according to the degree-of-interest evaluating system according to the embodiment, the terminal motion amount is categorized into the plurality of clusters based on the combination of the terminal motion amount regarding the changes in the terminal orientation per unit period of time and the terminal orientation for each unit period of time. The cluster corresponding to the attentive viewing state of the operator of the terminal for the content is identified. The terminal motion amount is categorized whether the terminal motion amount is of the inattentive viewing state of the operator of the terminal for the content based on the terminal motion amount belonging to the cluster corresponding to the attentive viewing state and the terminal motion amount in the predetermined operating state of the terminal. The parameters for evaluating the degree of interest of the operator of the terminal are determined based on the terminal motion amount belonging to the cluster corresponding to the attentive viewing state and the terminal motion amount in the inattentive viewing state. Thus, the parameters for calculating the degree of interest in accordance with the characteristics of the user may be obtained.

Variations of the above-described embodiment are described.

Although a case in which the degree-of-interest evaluating system includes the content server and the information processing terminal is described according to the above-described embodiment, this is not limiting. For example, a user information storage database may be provided so as to store the degree of interest on a user-by-user basis. In this case, the degree of interest of the user may be transmitted to the content server, and content to be provided from the content server to the information processing terminal may be changed in accordance with the degree of interest of the user.

Although an example in which the information processing terminal includes the touch state analyzing section, the motion amount data categorizing section, the parameter determining section, and the degree-of-interest evaluating section is described according to the above-described embodiment, this is not limiting. For example, a user information managing server may be provided, and the user information managing server may include the touch state analyzing section, the motion amount data categorizing section, the parameter determining section, and the degree-of-interest evaluating section. In this case, the input operation by the user, the sensor value of the terminal motion, and the terminal orientation are detected for each unit of time by the information processing terminal. Transmission may be performed from the information processing terminal to the user information managing server through the network, thereby the user information managing server analyzes the touch state, determines the parameters relating the reliability thresholds, and calculates the degree of interest.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium in which a degree-of-interest evaluating program for causing a computer to execute a process is recorded, the process comprising:
identifying,_based on a combination of a terminal motion amount relating to a change in an orientation of a terminal and information on the orientation of the terminal, a first cluster in which the terminal motion amount and the orientation of a terminal are in a specific state from a plurality of clusters into which the terminal motion amount is categorized;
determining whether the terminal motion amount belongs to an inattentive viewing state of an operator of the terminal for content based on an operating state of the terminal; and
determining a parameter to evaluate a degree of interest of the operator of the terminal based on the terminal motion amount which belongs to the first cluster and the terminal motion amount which belongs to the inattentive viewing state.

2. The non-transitory recording medium according to claim 1, the process further comprising:
categorizing the terminal motion amount into three or more of the clusters as the plurality of clusters; and
identifying as the first cluster a second cluster that satisfies a condition.

3. The non-transitory recording medium according to claim 2,
wherein the second cluster is a cluster including the smallest terminal motion amount of a cluster centroid, or, a cluster including the second smallest terminal motion amount of the cluster centroid when the smallest terminal motion amount of the cluster centroid is smaller than or equal to a threshold.

4. The non-transitory recording medium according to claim 1,
wherein the operating state includes a touch state of the terminal and a scrolling state of the terminal.

5. The non-transitory recording medium according to claim 4, the process further comprising:
determining, as inertial scrolling, the operating state in which the touch state is non-contact and a screen is being scrolled; and
categorizing, as the inattentive viewing state, the terminal motion amount that is of the terminal during the inertial scrolling and that is larger than the terminal motion amount belonging to the first cluster.

6. The non-transitory recording medium according to claim 5, the process further comprising:
categorizing, when the terminal motion amount of the terminal in the inertial scrolling is smaller than the terminal motion amount belonging to the first cluster, the terminal motion amount belonging to one of the clusters that includes the terminal motion amount larger than the terminal motion amount belonging to the first cluster as the terminal motion amount of the inattentive viewing state.

7. The non-transitory recording medium according to claim 1, the process further comprising:
determining, based on the terminal motion amount belonging to the cluster corresponding to the specific state, a first threshold of the terminal motion amount as a parameter of reliability which is for evaluating the degree of interest and reduces as the terminal motion amount increases, the first threshold causing the reliability to start reducing from a largest value of the reliability; and
determining the terminal motion amount with which the reliability is minimized or a second threshold which represents a degree of reduction of the reliability based on the terminal motion amount belonging to the inattentive viewing state.

8. The non-transitory recording medium according to claim 1, the process further comprising:
determining the parameter with respect to a period of time during which the content is displayed in the terminal so as to evaluate the degree of interest.

9. The non-transitory recording medium according to claim 1,
wherein one of a sum of squares of values of a three-axis angular velocity sensor, a sum of squares of values of a three-axis angular acceleration sensor, and a sum of squares of values of a three-axis magnetic sensor is used for the terminal motion amount.

10. The non-transitory recording medium according to claim 1,
wherein a value of a three-axis angular acceleration sensor or a value of a three-axis magnetic sensor is used for the information on the orientation.

11. An information processing device comprising:
a memory; and
a processor coupled to the memory and configured to:
identify, based on a combination of a terminal motion amount relating to a change in an orientation of a terminal and information on the orientation of the terminal, a first cluster in which the terminal motion amount and the orientation of a terminal are in a specific state from a plurality of clusters into which the terminal motion amount is categorized;
determine whether the terminal motion amount belongs to an inattentive viewing state of an operator of the terminal for content based on an operating state of the terminal; and
determine a parameter to evaluate a degree of interest of the operator of the terminal based on the terminal motion amount which belongs to the first cluster and the terminal motion amount which belongs to the inattentive viewing state.

12. The information processing device according to claim 11, the processor is configured to:
categorize the terminal motion amount into three or more of the clusters as the plurality of clusters; and
identify as the first cluster a second cluster that satisfies a condition.

13. The information processing device according to claim 11,
wherein the operating state includes a touch state of the terminal and a scrolling state of the terminal.

14. The information processing device according to claim 11, the processor is configured to:
determine, based on the terminal motion amount belonging to the cluster corresponding to the specific state, a first threshold of the terminal motion amount as a parameter of reliability which is for evaluating the degree of interest and reduces as the terminal motion amount increases, the first threshold causing the reliability to start reducing from a largest value of the reliability; and
determine the terminal motion amount with which the reliability is minimized or a second threshold which represents a degree of reduction of the reliability based on the terminal motion amount belonging to the inattentive viewing state.

15. The information processing device according to claim 11, the processor is configured to:
determine the parameter with respect to a period of time during which the content is displayed in the terminal so as to evaluate the degree of interest.

16. An evaluating method comprising:
identifying, by a computer, based on a combination of a terminal motion amount relating to a change in an orientation of a terminal and information on the orientation of the terminal, a first cluster in which the terminal motion amount and the orientation of a terminal are in a specific state from a plurality of clusters into which the terminal motion amount is categorized;
determining whether the terminal motion amount belongs to an inattentive viewing state of an operator of the terminal for content based on an operating state of the terminal; and
determining a parameter to evaluate a degree of interest of the operator of the terminal based on the terminal motion amount which belongs to the first cluster and the terminal motion amount which belongs to the inattentive viewing state.

17. The evaluating method according to claim 16, comprising:
categorizing the terminal motion amount into three or more of the clusters as the plurality of clusters; and
identifying as the first cluster a second cluster that satisfies a condition.

18. The evaluating method according to claim 16,
wherein the operating state includes a touch state of the terminal and a scrolling state of the terminal.

19. The evaluating method according to claim 16, comprising:
determining, based on the terminal motion amount belonging to the cluster corresponding to the specific state, a first threshold of the terminal motion amount as a parameter of reliability which is for evaluating the degree of interest and reduces as the terminal motion amount increases, the first threshold causing the reliability to start reducing from a largest value of the reliability; and
determining the terminal motion amount with which the reliability is minimized or a second threshold which represents a degree of reduction of the reliability based on the terminal motion amount belonging to the inattentive viewing state.

20. The evaluating method according to claim 16, comprising:
determining the parameter with respect to a period of time during which the content is displayed in the terminal so as to evaluate the degree of interest.
